(19) United States
(12) Patent Application Publication
(10) Pub. No.: US 2016/0063876 A1
(43) Pub. Date: Mar. 3, 2016

(54) Storytelling Device

(71) Applicant: Google, Inc., Mountain View, CA (US)

(72) Inventors: Ali Javan Javidan, Sunnyvale, CA (US); Frank Vincent Savino, San Carlos, CA (US); Aaron Arthur Weiss, Mountain View, CA (US); Norbert B. Tydingco, Newark, CA (US); Mark Anthony Zarich, Oakland, CA (US)

(21) Appl. No.: 14/592,080

(22) Filed: Jan. 8, 2015

Related U.S. Application Data
(60) Provisional application No. 62/044,101, filed on Aug. 29, 2014.

(51) Int. Cl. G09B 5/06; G06F 17/24

(52) U.S. Cl. CPC G09B 5/062; G06F 17/24

(57) ABSTRACT

This document describes a storytelling device. The storytelling device includes electronic output components, such as light sources, speakers, a video projector, or a display. The storytelling device is configured to establish an electronic connection with an interactive book, and to receive book data and sensor data from the interactive book via the electronic connection. Then, based on the sensor data and the book data, the storytelling device controls electronic output components, at the storytelling device and/or the interactive book, to provide story enhancement effects that are correlated to the interactive book.

### PRIORITY APPLICATION

This application is a non-provisional of and claims priority under 35 U.S.C. §119(e) to U.S. Patent Application Ser. No. 62/044,101, titled “Storytelling Device,” and filed on Aug. 29, 2014, the disclosure of which is incorporated by reference herein in its entirety.

### BACKGROUND

Recently some books, such as children's books, include an audio component that enriches the experience of reading the book. For example, the audio component may include physical control buttons and a speaker attached to the side of the book. The book itself may include words, pictures, and written instructions that tell the user to push specific buttons on the audio component to cause audio to be played via the speaker. The audio component and the book are not truly integrated, however, because there is no information exchanged between the book and the audio component.

### SUMMARY

This document describes an interactive book and a storytelling device. The interactive book includes sensors, electronic output components, such as light sources and speakers, and a memory that maintains book data. The sensors and the electronic output components are integrated into the book itself, such as within physical pages of the interactive book. The interactive book is configured to establish an electronic connection with the storytelling device. When the electronic connection is established, the book data is communicated from the interactive book to the storytelling device.

The storytelling device also includes electronic output components, such as light sources, speakers, a video projector, or a display. The storytelling device receives sensor data from the sensors of the interactive book. Then, based on the sensor data and the book data, the storytelling device controls the electronic output components, at the interactive book and/or at the storytelling device, to provide story enhancement effects that are correlated to the interactive book.

This summary is provided to introduce simplified concepts concerning an interactive book and a storytelling device, which is further described below in the Detailed Description. This summary is not intended to identify essential features of the claimed subject matter, nor is it intended for use in determining the scope of the claimed subject matter.

### BRIEF DESCRIPTION OF THE DRAWINGS

Embodiments of techniques and devices for an interactive book and a storytelling device are described with reference to the following drawings. The same numbers are used throughout the drawings to reference like features and components:

FIG. 1 is an illustration of an example environment in which an interactive book and a storytelling device may be embodied.

FIG. 2 illustrates a more-detailed example of the interactive book in accordance with various implementations.

FIG. 3 illustrates a more-detailed example of the storytelling device in accordance with various implementations.

FIG. 4 illustrates a system in which a story controller initiates story enhancement effects in accordance with various implementations.

FIG. 5 illustrates an implementation example in which story enhancement effects are triggered by a page turn.

FIG. 6 illustrates an additional implementation example in which story enhancement effects are triggered by a page turn.

FIG. 7 illustrates an additional implementation example in which story enhancement effects are triggered by voice input.

FIG. 8 illustrates an example method of communicating book data to a storytelling device.

FIG. 9 illustrates an example method of sensing user interaction with an interactive book to initiate story enhancement effects.

FIG. 10 illustrates an example method of receiving book data from an interactive book.

FIG. 11 illustrates an example method of controlling an electronic output component to provide a story enhancement effect for an interactive book.

FIG. 12 illustrates various components of an example computing system that can be implemented as any type of computing device as described with reference to the previous FIGS. 1-11 to implement the interactive book or the storytelling device.

### DETAILED DESCRIPTION

Overview

This document describes an interactive book and a storytelling device. The interactive book includes sensors (e.g., a page sensor, a touch sensor, and a microphone) and electronic output components (e.g., light sources and a speaker). Unlike conventional solutions, the sensors and the electronic output components are integrated into the book itself, such as by being embedded in physical pages of the interactive book.

The interactive book also includes a memory which maintains book data usable to provide various story enhancement effects correlated to the story of the interactive book. For example, the book data maps control signals for the story enhancement effects to sensor data generated by the sensors of the interactive book. In one or more implementations, the interactive book does not include logic or controllers for processing the book data to provide the story enhancement effects.

The storytelling device is a separate device that forms an electronic connection with an interactive book. The storytelling device includes logic and controllers configured to process book data received from the interactive book to provide story enhancement effects that are correlated to the interactive book. The storytelling device is “story agnostic” because the storytelling device is not associated with any one particular interactive book. Instead, the storytelling device is designed to control multiple different interactive books using book data received when connected to each respective interactive book.

The storytelling device also includes a power source for the interactive book, and electronic output components, such as light sources, speakers, a projector, or a display. Integrating the logic, power, and electronic output components with the storytelling device reduces the cost of manufacturing each interactive book. Notably, this also reduces the cost of each interactive book to consumers, and diminishes the consumer's loss if a single interactive book is destroyed by a rambunctious toddler.

Both the storytelling device and the interactive book are inoperable until the electronic connection is established. When the electronic connection is established, however, the storytelling device provides power to the interactive book, and the interactive book communicates the book data to the storytelling device. The storytelling device then uses the book data to provide story enhancement effects as the user interacts with the interactive book.

In operation, the storytelling device receives sensor data from the sensors of the interactive book as the reader interacts with the interactive book, such as by turning pages of the interactive book or touching touch sensors within the pages. Based on the sensor data and the book data, the storytelling device controls the electronic output components, at the interactive book and/or at the storytelling device, to provide story enhancement effects that are correlated to the interactive book. To do so, the storytelling device communicates control signals to the electronic output components, at the interactive book and/or the storytelling device, to cause the electronic output components to provide the story enhancement effects, such as by outputting light or playing audio or video content.

Thus, the interactive book and the storytelling device are truly integrated because, unlike conventional solutions, there is a “two-way” information exchange between the interactive book and the storytelling device. The interactive book communicates book data and sensor data to the storytelling device, and the storytelling device communicates control signals back to electronic output components of the interactive book.

Example Environment

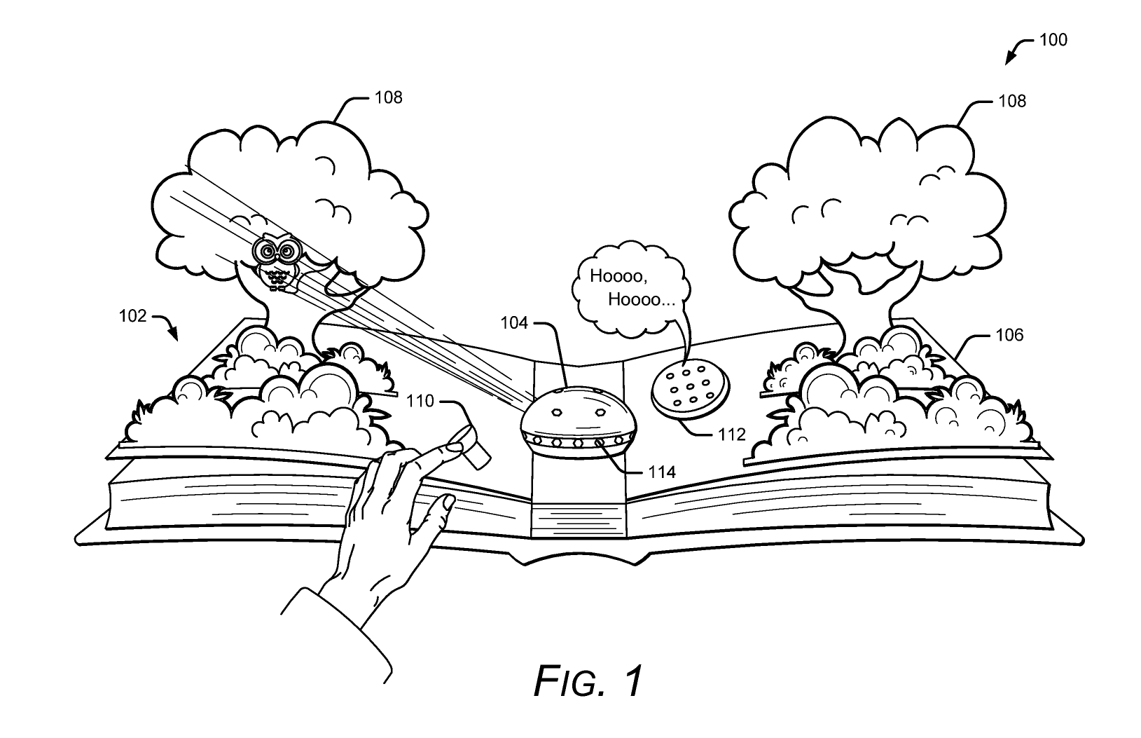

FIG. 1 is an illustration of an example environment 100 in which an interactive book and a storytelling device may be embodied. Interactive book 102 is configured to enable user interaction with a story of the interactive book, and storytelling device 104 is configured to assist interactive book 102 in telling the story by controlling various story enhancement effects which are correlated to the story.

Interactive book 102 is a physical book and includes physical pages (“pages”) 106, which may be implemented with a physical material such as paper, cardboard, or plastic, to name just a few. Each page 106 of interactive book 102 may include text or images like many standard physical books.

In one or more implementations, interactive book 102 includes three-dimensional pop-up elements (“pop-up elements) 108, which pop-up and out of pages 106 of interactive book 102 when the reader turns to a particular page. Such pop-up elements may commonly be found in children's books, and may be made from any type of sturdy material, such as cardboard, plastic, and so forth. In environment 100, pop-up elements 108 include two trees that pop-up from interactive book 102 when the reader turns to page 106. While many examples described herein will reference pop-up elements, in some cases interactive book 102 may be implemented without pop-up elements.

Interactive book 102 also includes sensors 110 that are configured to sense various types of input. For example, sensors 110 may include a page sensor configured to sense a current page of interactive book 102, a touch sensor configured to sense touch input and gestures, a microphone configured to sense voice input, or a motion sensor configured to sense motion input. Sensors 110 are integrated within interactive book 102, such as by being embedded within pages 106 of interactive book 102 or in the spine of interactive book 102.

In environment 100, sensor 110 is illustrated as a touch sensor that is embedded in page 106 and associated with an image of a flashlight. The touch sensor is configured to receive touch input when the reader's finger touches the image of the flashlight. In one or more implementations, interactive book 102 does not include a dedicated power source, thus, without storytelling device 104, sensors 110 of interactive book 102 are inoperable.

Interactive book 102 is configured to establish an electronic connection with storytelling device 104. The electronic connection enables data and control signals to be transferred between interactive book 102 and storytelling device 104. In addition, storytelling device 104 provides a power source for interactive book 102 through the electronic connection. In this example, storytelling device 104 is connected to the spine of interactive book 102, such that storytelling device 104 is positioned in the center of interactive book 102 when opened. For example, each page of interactive book 102 includes a hole in the center that enables storytelling device to connect to the spine of interactive book 102.

Storytelling device 104 is configured to enhance the reading of interactive book 102 by controlling various “story enhancement effects,” which are specifically correlated to interactive book 102. As described herein, a “story enhancement effect” corresponds to output by one or more electronic output components, such as playing audio through a speaker, outputting light using a light source, or displaying video using a video projector or a display.

Both the interactive book 102 and storytelling device 104 may include electronic output components, which are depicted as electronic output components 112 and 114, respectively. In this example, electronic output component 112 is depicted as a speaker that is integrated within page 106 of interactive book 102, and electronic output component 114 is depicted as light sources positioned around an outer surface of storytelling device 104. Note that the positioning of storytelling device 104 enables storytelling device 104 to shine light from the light sources to illuminate a currently opened page 106 (e.g., the page currently being read by the reader) of interactive book 102.

Storytelling device 104 includes logic and controllers to control electronic output components 112 and 114 to provide the story enhancement effects. However, storytelling device 104 is “story agnostic”, which means that the storytelling device need not include data or instructions for any one particular story.

In contrast, interactive book 102 includes book data usable to control the story enhancement effects for interactive book 102, but may not include logic or controllers configured to use the book data. The book data maps sensor data generated by sensors 110 to various story enhancement effects, and provides control signals usable to control electronic output components 112 and/or 114 to provide the story enhancement effects. Additionally, the book data may include media data, such as audio files or video files, associated with interactive book 102. In FIG. 1, for example, the book data may include an audio file that can be played to output the sound an owl might make, such as “hoooo, hoooo”.

Interactive book 102 communicates the book data to storytelling device 104 when the electronic connection between interactive book 102 and storytelling device 104 is established. This enables storytelling device 104 to use the book data received from interactive book 102 to control various story enhancement effects which are correlated to interactive book 102.

In this example, when the user's finger touches the touch sensor integrated into page 106, it causes storytelling device 104 to initiate story enhancement effects by controlling the light sources of storytelling device 104 to illuminate the tree pop-up element 108, which enables the reader to see an owl in the tree. Additionally, storytelling device 104 causes the speaker in interactive book 102 to play the audio file to make the “hoooo, hoooo” sound. Note, therefore, that the story enhancement effects are specifically correlated interactive book 102. The light sources are controlled to illuminate an exact area of the tree at which the owl is located, and the speakers are controlled to make the “hooo, hooo” sound at the exact time the owl is illuminated.

Having discussed an environment in which an interactive book and a storytelling device may be embodied, now consider a more-detailed discussion of interactive book 102.

Interactive Book

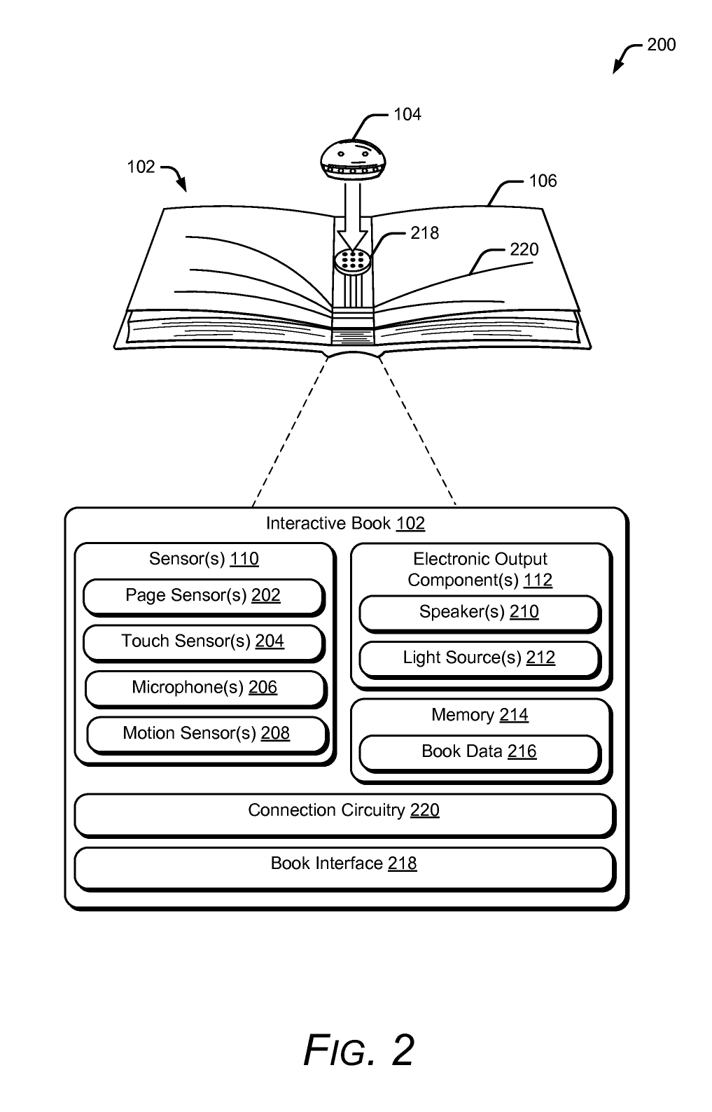

FIG. 2 illustrates a more-detailed example 200 of interactive book 102 in accordance with various implementations.

In this example, interactive book 102 includes sensors 110, which include, by way of example and not limitation, a page sensor 202, a touch sensor 204, a microphone 206, and a motion sensor 208. As discussed above, each of the sensors 110 may be integrated into interactive book 102, such as by being embedded in a page 106 of interactive book 102, or at any other position within interactive book 102, such as in the spine of interactive book 102. Interactive book 102 may not include a power source or controllers for the sensors, which decreases the cost of manufacturing each interactive book 102.

Each sensor 110 is configured to sense user interaction with interactive book 102, and to generate sensor data corresponding to the user interaction. The sensor data may include an identifier of the sensor, as well as the user interaction detected. For example, if touch input is sensed by a touch sensor on page 5 of interactive book 102, the touch data includes an identifier of the touch sensor on page 5, and the user interaction detected (e.g., single touch, double tap, or swipe up). Interactive book 102 communicates the sensor data to storytelling device 104 effective to cause the storytelling device 104 to initiate a story enhancement effect based on the sensor data.

Page sensor 202 is configured to sense the current page 106 of interactive book 102, which is currently open, and to output page data indicating the current page 106. In FIG. 1, for example, page sensor 202 may detect the current page 106 of interactive book 102 when the reader turns to the page with the tree pop-up elements.

In one or more implementations, page sensor 202 is implemented as a flex sensor. Flex sensors are configured to change in resistance or voltage when they flex or bend. For example, the flex sensor may output a high resistance value with a high amount of bend, and a low resistance value with a low amount of bend. Thus, the flex sensor may be attached around the hinge of interactive book 102 to sense the current page of interactive book 102 that is opened. For example, the resistance values of the flex sensor may be mapped to each page of interactive book 102 to enable storytelling device 104 to determine the current page based on the resistance value of the flex sensor.

Touch sensor 204 is configured to sense touch input when a user touches touch sensor 204, and to generate touch data corresponding to the touch input. Touch sensor 204 may be configured to detect a single touch or tap, multi-finger touches and taps (e.g., two-finger touches), and/or gestures (e.g., swiping up, down, left, or right). In FIG. 1, for example, touch sensor 204 detects touch input when the user's finger touches the touch sensor associated with the flashlight. Touch sensor 204 may be implemented as any type of sensor configured to receive touch input, such as a capacitive touch sensor, a resistance touch sensor, or a piezo touch sensor, to name just a few.

Microphone 206 is configured to sense audio input when a reader speaks, and to generate audio data corresponding to the audio input. Thus, microphone 206 may be able to sense specific utterances from a user, which can be used to initiate various story enhancement effects.

Motion sensor 208 is configured to sense motion input, and generate motion data corresponding to the motion input. For example, motion sensor 208 may be able to sense when the user shakes interactive book 102, picks up interactive book 102, drops interactive book 102, and so forth. Motion sensor 208 may be implemented as any type of sensor configured to sense motion, rotation, and so forth, and thus may be implemented as an accelerometer or a gyroscope, to name just a few.

While sensors 110 are described as including page sensor 202, touch sensor 204, microphone 206, and motion sensor 208, note that sensors 110 may include any type of sensor that can be integrated into a physical book.

In this example, interactive book 102 includes electronic output components 112 which include, by way of example and not limitation, speakers 210 and light sources 212.

Speakers 210 are configured to receive control signals and audio files from storytelling device 104, and to output audio. Speakers 210 can output any type of audio, such as animal sound effects, a voice reading the story of interactive book 102, or a song corresponding to interactive book 102. Speakers 210 may be implemented as small, lightweight speakers, such as those commonly found on greeting cards. Thus, speakers 210 may be placed on individual pages 106 of interactive book 102. Alternately, speakers 210 may be implemented elsewhere, such as in the spine of interactive book 102.

Light sources 212 are configured to receive control signals from storytelling device 104, and to output light based on the control signals. Light sources 212 may be implemented as any type of light source. In one or more implementations, light sources 212 are implemented as light-emitting-diodes (LEDs). Light sources 212 may be controlled to perform various types of lighting effects, such as flickering, twinkling, blinking, and so forth.

Interactive book 102 further includes a memory 214 that maintains book data 216. Book data 216 provides a blueprint for controlling electronic output components 112 and/or 114 to provide story enhancement effects that are specifically correlated to interactive book 102. Book data 216 is specific to the story of interactive book 102. For example, book data 216 for a first interactive book 102 with a story about trucks is not the same as book data 216 for a second interactive book 102 with a story about animals.

In one or more implementations, book data 216 includes a mapping between sensor data generated by sensors 110 and story enhancement effects. Thus, the sensor data can be used to “trigger” the story enhancement effects. For example, turning to a specific page may generate page data that triggers a story enhancement effect that is specifically correlated to the specific page. As another example, touching a specific touch sensor may generate touch data that triggers a story enhancement effect that is specifically correlated to the page on which the touch sensor is located. As described above, the sensor data may include an identifier of the sensor, as well as the sensed user interaction. Thus, book data 216 enables storytelling device 104 to compare sensor data to the mapping between sensor data and story enhancement effects of book data 216, and to determine the story enhancement effect to provide based on the comparison.

Additionally, for each story enhancement effect in the mapping, book data 216 provides control signals usable to control electronic output components 112 at interactive book 102 and/or electronic output components 114 at storytelling device 104 to provide the story enhancement effect. Thus, as discussed in more detail below, storytelling device 104 can use the control signals to control the electronic output components to provide output corresponding to the story enhancement effect that is specifically correlated to the layout of the current page that is open. For example, the control signals are usable to control light sources to illuminate a specific region of a pop-up element 108 on a page 106 that is currently open.

Book data 216 may also include media files that can be used to output media content (e.g., audio and/or video content). For example, book data 216 may include a digital audio file corresponding to a particular sound effect, voice utterance, or song that is specific to interactive book 102. The digital audio file may be implemented as any type of digital audio file, such MP3, WAV, and so forth. As another example, book data 216 may include a digital video file corresponding to video clips or video effects that are specific to interactive book 102. The digital video file may be implemented as any type of digital video file, such as AVI, MOV, WMV, and so forth.

Interactive book 102 is configured to communicate book data 216 to storytelling device 104 when an electronic connection is established with storytelling device 104. Doing so enables storytelling device 104 to control electronic output components 112 and/or 114 to provide story enhancement effects that are correlated to interactive book 102.

To establish the electronic connection, interactive book 102 includes a book interface 218 and connection circuitry 220 which connects book interface 218 to sensors 110 and electronic output components 112. In one or more implementations, book interface 218 is implemented as spring-loaded pogo pins which are configured to connect to corresponding pogo pins on storytelling device 104. However, book interface 218 may also be implemented as other types of connective interfaces that enable the transfer of data, control signals, and power between interactive book 102 and storytelling device 104.

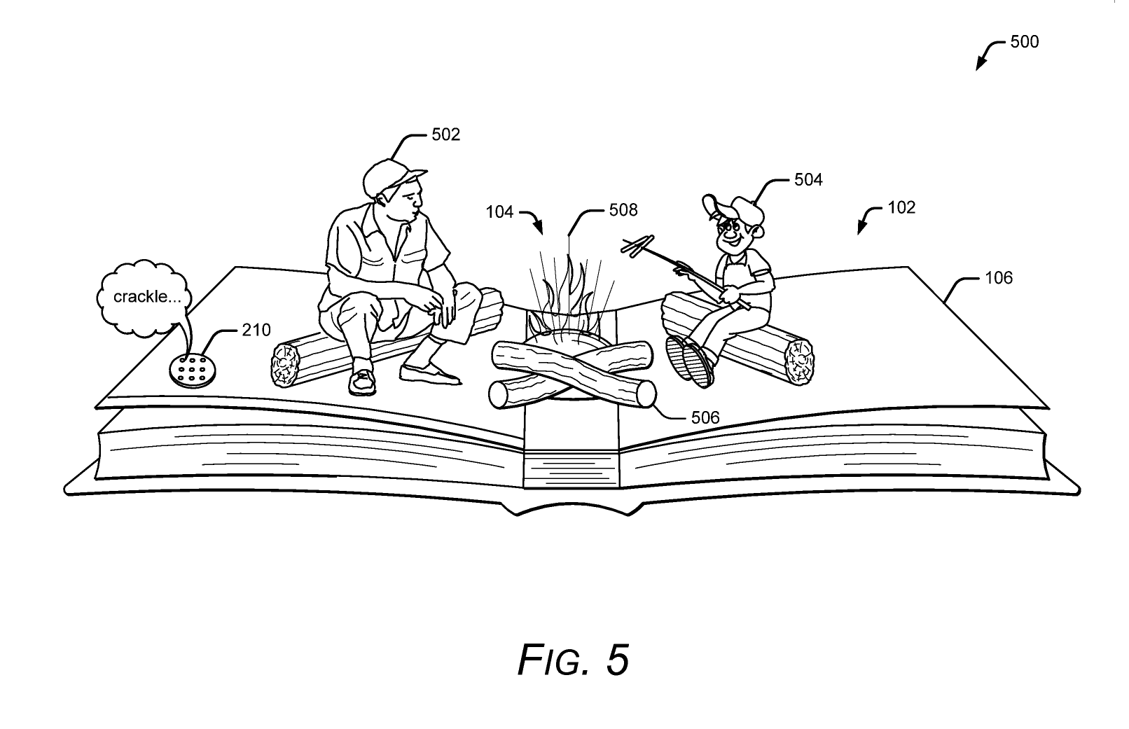

In this example, book interface 218 is positioned in the center of interactive book 102. The bottom of storytelling device 104 is configured to connect to book interface 218, such that storytelling device 104 is positioned in the center of interactive book 102 when the book is open. Each page 106 may include a circular cut-out to enable storytelling device 104 to be visible when any page 106 is open. In some cases, interactive book 102 may include pop-up elements 108 that pop-up and cover storytelling device 104. Examples of such pop-up elements are discussed with regards to FIGS. 5, 6, and 7, below.

Connection circuitry 220 connects to interface 218, and can be embedded into pages 106 to connect interface 218 to sensors 110 and electronic output components 112 in pages 106. In this example, connection circuitry 220 connects to interface 218 in the spine of interactive book 102, and the runs down the spine of interactive book 102, and into pages 106.

In one or more implementations, to reduce the amount of wiring of connection circuitry 220, small sensor boards may be placed on each page 106 that can control sensors 110 and electronic output components 112 on the particular page 106. This configuration reduces the amount of wiring of connection circuitry 220 that is needed to connect each sensor 110 and electronic output component 112 to book interface 218.

When the electronic connection is established with storytelling device 104, book data 216 is communicated from memory 214 on interactive book 102 to storytelling device 104. In some cases, interactive book 102 may automatically communicate book data 216 to storytelling device 104 responsive to detecting that the electronic connection with storytelling device 104 is established. Alternately, when the electronic connection is established, storytelling device 104 may communicate a request to interactive book 102. Responsive to receiving the request, interactive book 102 communicates book data 216 to storytelling device 104.

Having discussed interactive book 102, consider now a more-detailed discussion of storytelling device 104.

Storytelling Device

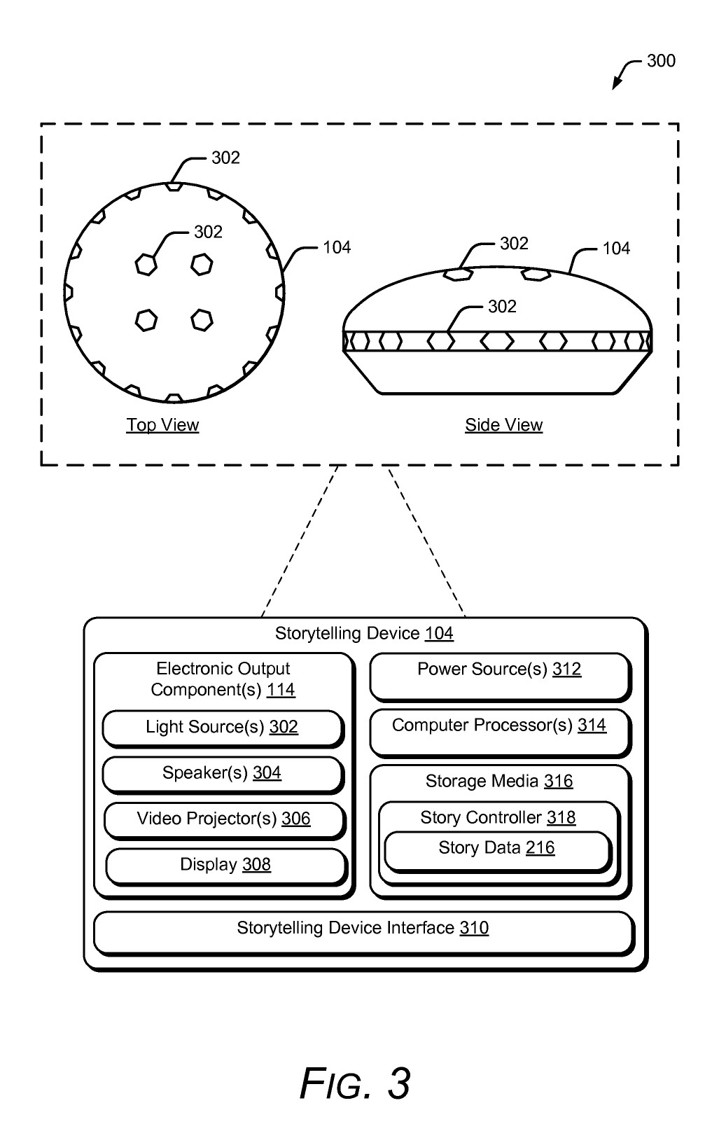

FIG. 3 illustrates a more-detailed example 300 of storytelling device 104 in accordance with various implementations.

As described throughout, storytelling device 104 is a separate device that can be attached or detached from interactive books 102, and includes centralized logic and controllers configured to process book data 216 and sensor data received from interactive book 102 to provide story enhancement effects that are correlated to interactive book 102.

In this example, the shape of storytelling device 104 is semi-spherical, and resembles a “puck” or a “stone”. It is to be appreciated, however, that storytelling device 104 is not limited to this spherical design.

Storytelling device 104 includes electronic output components 114, which include, by way of example and not limitation, light sources 302, speakers 304, video projectors 306, and a display 308. Storytelling device 104 may include additional electronic output components 114, or just a subset of the electronic output components 114 illustrated in FIG. 3. For example, in some cases, storytelling device 104 may be implemented in different versions, such that a more-expensive, premium version may include video projector 306 or display 308, whereas a less-expensive, basic version may not include video projector 306 and display 308.

Light sources 302 may be implemented as any type of light source, such as LEDs. Light sources 302 are configured to receive control signals from storytelling device 104, and to output light based on the control signals. In this example, light sources 302 are positioned on the outer surface of storytelling device 104. As shown in a “top view” and a “side view”, light sources 302 may be positioned around the perimeter of storytelling device 104 and configured to project light towards pages 106. Positioning light sources 302 around storytelling device 104 enables light to reach any area of interactive book 102. Alternately or additionally, storytelling device 104 may include light sources 302 positioned on a top surface of storytelling device 104, as illustrated in the top view.

In one or more implementations, light sources 302 may include high-intensity LEDs and low-intensity LEDs. The high-intensity LEDs can be controlled to shine out and illuminate parts of interactive book 102, such as pop-up elements 108, while the low-intensity LED's may be controlled to glow softly.

Speakers 304 are configured to receive audio files and control signals from storytelling device 104, and to output audio. Speakers 304 can output any type of audio, such as animal sound effects, a voice reading the story of interactive book 102, or a song corresponding to interactive book 102. In some cases, storytelling device 104 may not include speakers, and instead use speakers 210 embedded in interactive book 102. Alternately, interactive book 102 may not include speakers 210 in which case speakers 304 of storytelling device 104 can be used for all audio output.

Video projector 306 is configured to receive video files and control signals from storytelling device 104, and to project video. In one or more implementations, video projector 306 is implemented as a small “pico” projector. Video projector 306 may be controlled to project the video onto specific areas of interactive book 102 to interact with areas of the book, such as pop-up elements 108. In FIG. 1, for example, video projector 306 could be controlled to project video of the owl into the tree pop-up element, instead of relying on the light sources to illuminate the owl. Video projector 306 may also be controlled to project video to areas outside of interactive book 102. For example, video projector 306 may be configured to project images or video, such as images or video of the moon and stars, onto the ceiling in a room in which the reader is reading interactive book 102.

Display 308 is configured to receive video or image files and control signals from storytelling device 104, and to display images or video. Display 308 may be implemented as any type of display, such as a liquid crystal display (LCD) or other types of high-resolution displays. In some cases, display 308 may be a circular display, similar to what might be found on a conventional smartwatch. Display 308 may positioned so that it covers the top portion of storytelling device.

Consider that display 308 may be used to display images corresponding to interactive book 102, or even text of the story of interactive book 102. For example, rather than including the text of the story on individual pages 106, display 308 can display text of the story that changes as each page is turned. Consider also that text of the story could be displayed in any language by display 308, which would allow a single version of interactive book 102 to be compatible with multiple languages.

Storytelling device 104 includes a storytelling device interface 310 that is configured to establish an electronic connection to interactive book 102. For example, the bottom of storytelling device 104 may include pogo pins designed to connect to the pogo pins of book interface 218. Of course, any type of connective interface may be used to connect storytelling device 104 to interactive book 102.

Storytelling device 104 includes a power source 312, which may be implemented as any type of chargeable or removable battery. Power source 312 is configured to provide power to storytelling device 104. In one or more implementations, power source 312 also provides power to sensors 110 and electronic output components 112 of interactive book 102 via the electronic connection between storytelling device interface 310 and book interface 218. Placing the power source for interactive book 102 on storytelling device 104, instead of interactive book 102, decreases the cost of manufacturing each interactive book 102 thereby also decreasing the cost to the consumer.

Storytelling device 104 includes one or more computer processors 314 and computer-readable storage media (storage media) 316. Applications and/or an operating system (not shown) embodied as computer-readable instructions on storage media 316 can be executed by computer processors 314 to provide some or all of the functionalities of storytelling device 104 described herein. Storage media 316 also includes a story controller 318.

Story controller 318 receives book data 216 from interactive book 102, and uses book data 216 to initiate story enhancement effects by communicating control signals to electronic output components 112 and 114. Storytelling device 104 may include various electronic output component microcontrollers, such as an LED microcontroller configured to control LEDs, an MP3 audio codec microcontroller configured to play audio through speakers, and so forth. Thus, in some cases, story controller 318 may utilize the various microcontrollers associated with the electronic output components to initiate the story enhancement effects.

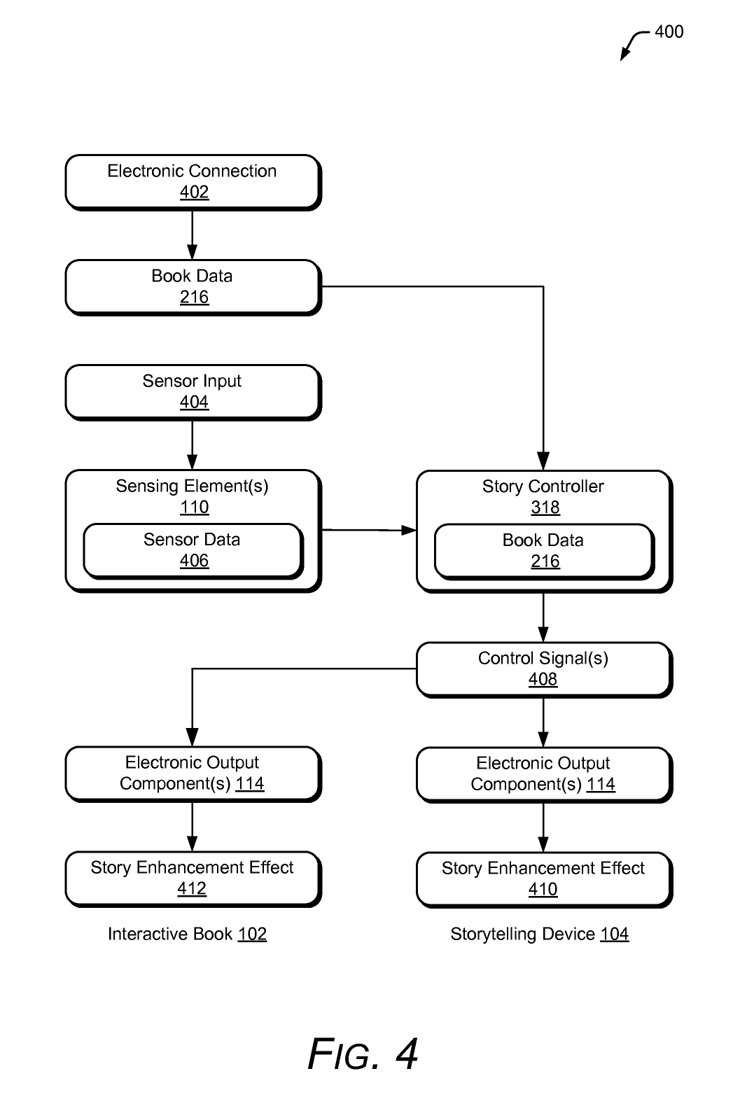

In order to better understanding the functionality of story controller 318, consider FIG. 4, which illustrates a system 400 in which story controller 318 initiates story enhancement effects in accordance with various implementations.

In example 400, interactive book 102 communicates book data 216 to storytelling device 104 responsive to an electronic connection 402 being established between interactive book 102 and storytelling device 104. For example, as discussed previously, the electronic connection is established when book interface 218 is connected to storytelling device interface 310.

Book data 216 includes a mapping between sensor data generated by sensors 110 and story enhancement effects. Additionally, for each story enhancement effect, book data 216 includes control signals usable to control an electronic output component to provide the story enhancement effect. Book data 216 may also include media files, such as audio files or video files that can be used to play media content.

For example, in environment 100 of FIG. 1, book data 216 may include an audio file corresponding to the “hoooo, hoooo” sound and a mapping between touch data generated by the touch sensor on page 106 and story enhancement effects corresponding to illuminating the tree pop-up element and causing the speaker to make the “hoooo, hoooo” sound. In addition, book data 216 may include control signals usable to control the light sources on storytelling device 104 to illuminate the tree pop-up element 108 on page 106 and to play the audio file using the speaker embedded in page 106 of interactive book 102.

As a reader begins reading and interacting with interactive book 102, sensors 110 receive sensor input 404. For example, sensor input 404 may include page input corresponding a current page turned to by the reader sensed by page sensor 202. Alternately or additionally, sensor input 404 may correspond to touch input sensed by touch sensor 204, voice input sensed by microphone 206, motion input sensed by motion sensor 208, and so forth.

Next, sensor 110 generate sensor data 406 based on the sensor input. For example, page sensor 202 can generate page data based on page input, touch sensor 204 can generate touch data based on touch input, microphone 206 can generate voice data based on voice input, and motion sensor 208 can generate motion data based on motion input. Returning to FIG. 1, consider that page data is generated by page sensor 202 when the user turns to page 106. Further, touch data is generated by touch sensor 204 when the user touches the touch sensor associated with the flashlight. Sensor data 406 may include an identifier of the sensor, as well as the user interaction detected.

Interactive book 102 communicates sensor data 406 to storytelling device 104. To do, sensor data 406 is routed to book interface 218 via connection circuitry 220. Book interface 218 then provides sensor data 406 to storytelling device 104 via storytelling device interface 310.

Story controller 318 uses sensor data 406 to initiate story enhancement effects that are correlated to interactive book 102. To do so, story controller 318 compares sensor data 406 to book data 216. For example, story controller 318 compares the identifier of the sensor and the user interaction detected by the sensor in sensor data 406 to the mapping of book data 216. Then, story controller 318 selects a story enhancement effect from the mapping between sensor data and story enhancement effects in book data 216 based on sensor data 406. Next, story controller 318 initiates the story enhancement effect by transmitting control signals 408, associated with the selected story enhancement effect in book data 216, to electronic output components 112 and 114.

For example, control signals 408 are communicated to electronic output component 114, at storytelling device 104, to cause electronic output component 114 to provide story enhancement effect 410. In FIG. 1, for example, a control signal is communicated to the light sources of storytelling device 104 to cause the light sources to provide the story enhancement effect by illuminating the tree pop-up element 108, which enables the reader to see an owl in the tree.

Similarly, control signals 408 are communicated to electronic output component 112, at interactive book 102, to cause electronic output component 112 to provide story enhancement effect 412. For example, in FIG. 1, control signals 408 cause the speaker in interactive book 102 to provide the story enhancement effect by outputting audio corresponding to the “hoooo, hoooo” sound of an owl.

Having discussed examples of interactive device 102 and storytelling device 104, consider now various implementation examples in which interactive book 102 and storytelling device 104 may be implemented.

### Implementation Examples

FIG. 5 illustrates an implementation example 500 in which story enhancement effects are triggered by a page turn.

In this example, the reader has turned to a page 106 of interactive book 102, which includes pop-up elements 108 in the form of a father 502 and a son 504 sitting around a campfire 506. Unlike FIG. 1 where storytelling device 104 is exposed in the center of interactive book 102, in this example storytelling device 104 is at least partially covered by the pop-up element of campfire 506. For example, campfire 506 includes logs placed over storytelling device 104. In addition, campfire 506 may include red, yellow, or orange color vellums and/or transparencies that cover storytelling device 104.

When the user turns to page 106, page sensor 202 senses the current page as input and communicates page data to storytelling device 104. Storytelling device 104 accesses book data 216, to determine a story enhancement effect that is associated with the current page indicated by the page data. In this case, book data 216 instructs storytelling device 104 to twinkle the light sources (not pictured) positioned on the top of the storytelling device 104. Thus, storytelling device 104 communicates control signals to light sources 302 on the top of storytelling device 104 to cause the light sources to output twinkling light rays 508. The red, orange, and yellow color vellums or transparencies of campfire 506, which overlap storytelling device 104, interact with light rays 508 output by light sources 302 to provide a story enhancement effect that resembles a real campfire.

In this example, book data 216 also includes an audio file corresponding to the sound of a crackling fire, and control signals usable to play the audio file through speaker 210 based on the current page 106. Thus, storytelling device 104 causes speaker 210 to play the cracking fire sound to provide a story enhancement effect corresponding to a real campfire.

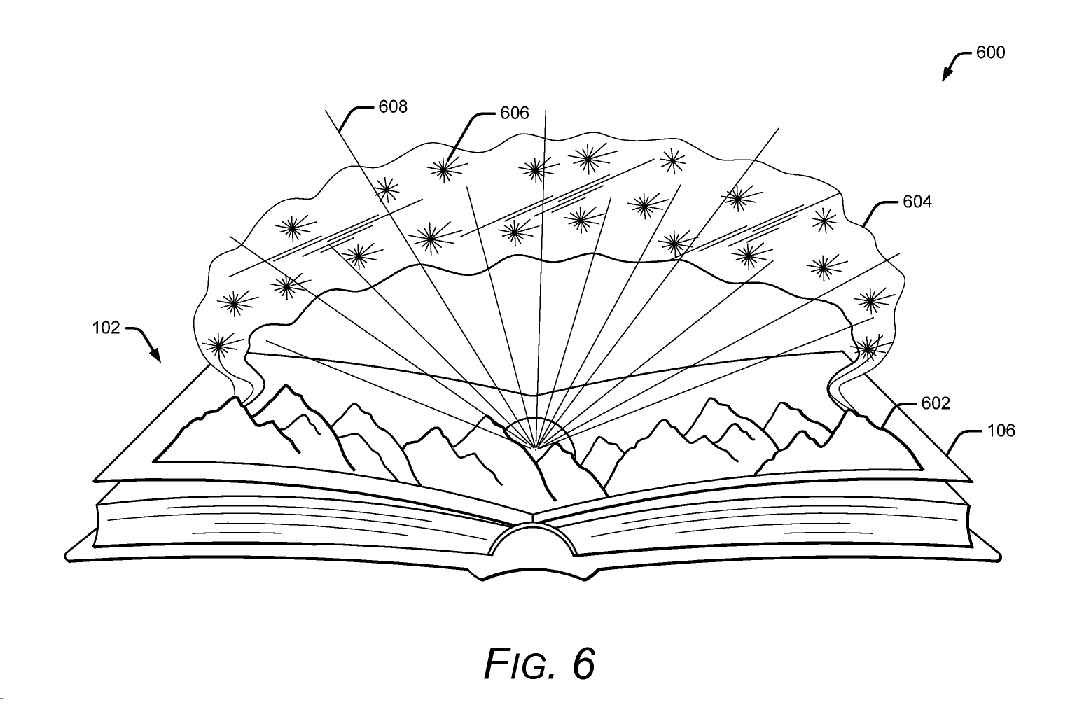

FIG. 6 illustrates an additional implementation example 600 in which story enhancement effects are triggered by a page turn. In this example, the reader has turned to a page 106 of interactive book 102, which includes pop-up elements 108 in the form of a mountain range 602 and an aurora 604. Mountain range 602 blocks storytelling device 104 from the front, while aurora 604 goes over the top of interactive book 102 thereby blocking the view of storytelling device 104 from the top. Aurora 604 is constructed from a semi-transparent paper, and includes multiple light sources 606 embedded into the actual paper or material of aurora 604.

When the user turns to the current page 106, page sensor 202 senses the current page as input and communicates page data to storytelling device 104. Storytelling device 104 accesses book data 216, to determine story enhancement effects to apply based on the page data. In this case, book data 216 instructs storytelling device 104 to output light rays 608 using light sources 302 of storytelling device to cause aurora 604 to “glow”, and to cause light sources 606 embedded in aurora 604 to twinkle to resemble stars in the aurora. Thus, storytelling device initiates these story enhancement effects by communicating control signals to light sources 302 and 306.

Thus, similar to FIG. 5, the story enhancement effects are triggered by a page turn. Unlike FIG. 5, however, storytelling device 104 controls electronic output components 112 that are embedded into a pop-up element 108 of page 106.

In one or more implementations, storytelling device 104 could also control video projector 306 to project a video or static images onto page 106. For example, video projector 306 could be controlled to project a video of a person climbing mountain range 602.

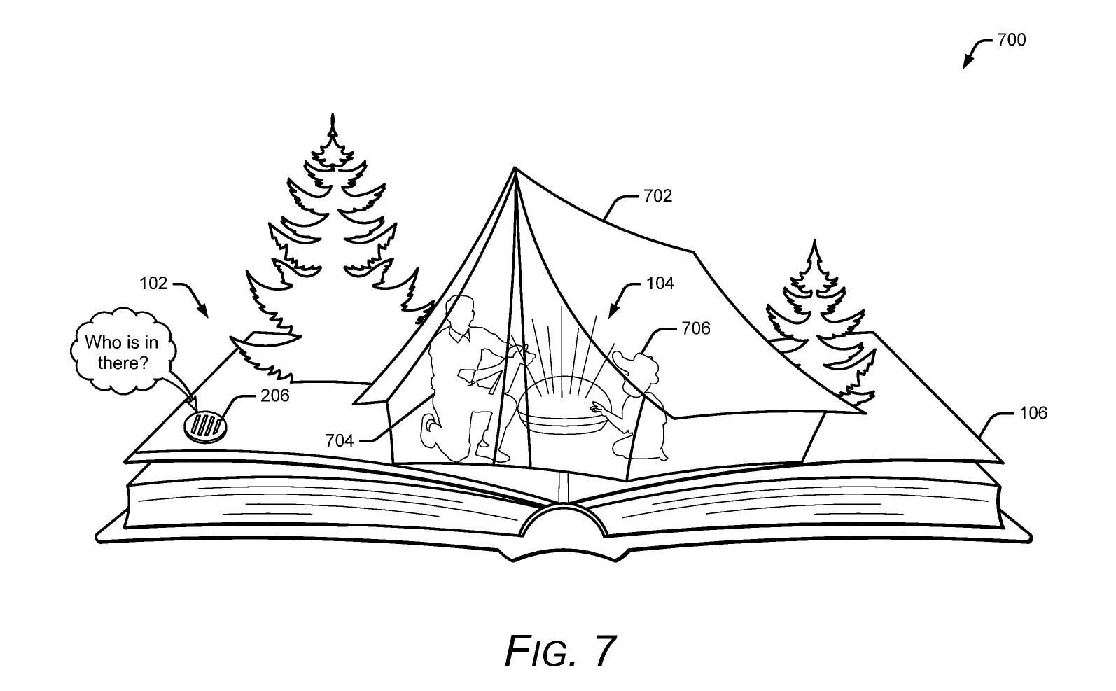

FIG. 7 illustrates an additional implementation example 700 in which story enhancement effects are triggered by voice input. In this example, the reader has turned to a page 106 of interactive book 102 which includes pop-up elements 108 in the form of a tent 702 that covers storytelling device 104.

Page 106 includes a microphone 206 that is configured to receive voice input. When the reader says, “who is in there?” microphone 206 senses voice input and communicates voice data to storytelling device 104. Storytelling device 104 accesses book data 216, to determine a story enhancement effect to initiate based on the voice data. In this case, book data 216 instructs storytelling device 104 to use light sources 302 on storytelling device 104 to illuminate tent 702. Thus, storytelling device 104 communicates control signals to light sources 302 to cause light sources 302 to illuminate tent 702. When tent 702 is illuminated, the reader is able to see pop-up elements 108 of a father 704 and a son 706 within tent 702.

While the examples above describe some of the functionality of storytelling device 104 and interactive book 102, it is to be appreciated that a variety of other story enhancement effects may be initiated by storytelling device 104 using electronic output components located at storytelling device 104 and/or interactive book 102. Further, the story enhancement effects may be triggered by various different types of sensor data, including different combinations of sensor data. For example, in some cases the story enhancement effects are triggered by page data, while in other cases the story enhancement effects are triggered by sensor data other than page data, such as touch data, voice data, or motion data. Further, in some cases the story enhancement effects may be triggered by different combinations of sensor data, such as page data and touch data, voice data and motion data, and so forth.

Notably, the specifications and capabilities of storytelling device 104 can be provided to developers to enable development of a wide variety of different types of interactive books that are designed to be controlled by storytelling device 104. For example, the specifications can tell developers the types of functions storytelling device 104 can perform, as well as the control signals and instructions needed to trigger these functions. In this way, developers of interactive book 102 are able to create fun, imaginative, and engaging interactive books that encourage user interaction and enable the storytelling device to provide story enhancement effects that bring interactive books to life.

Example Methods

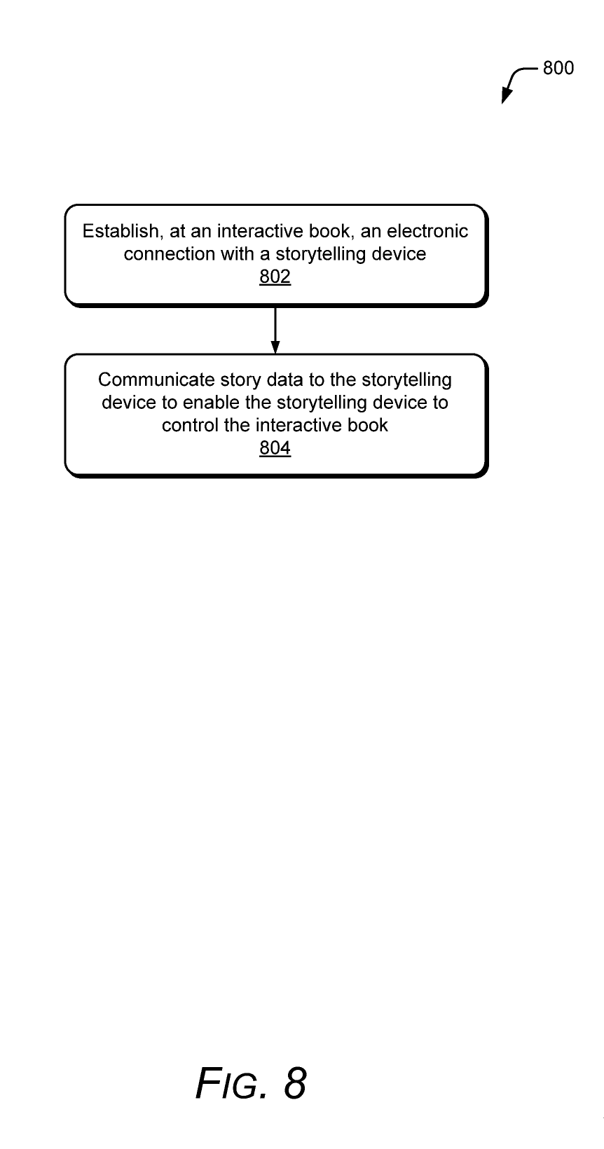

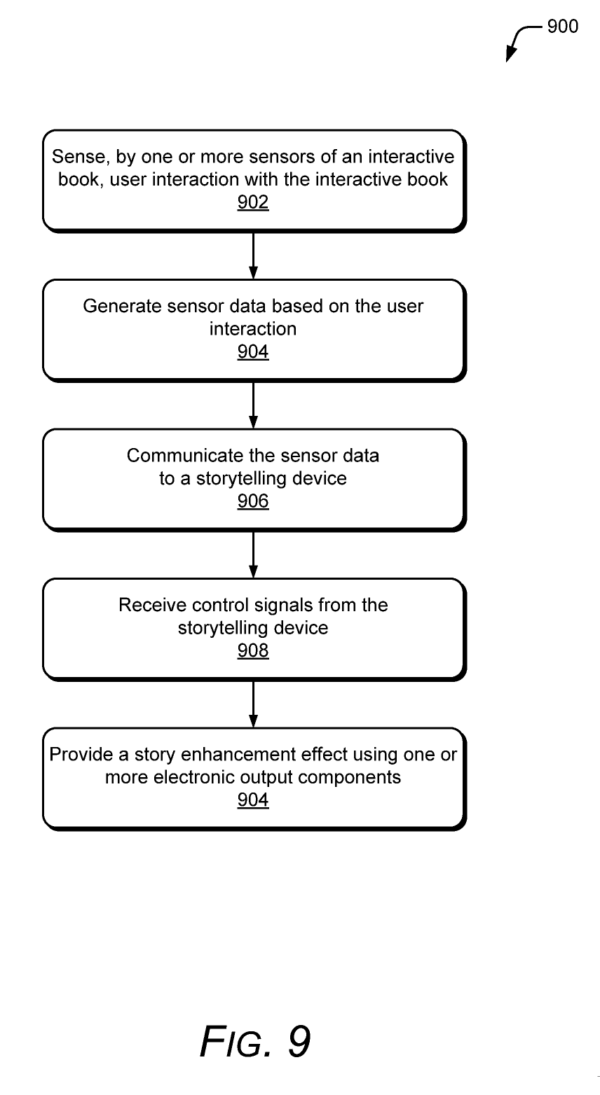

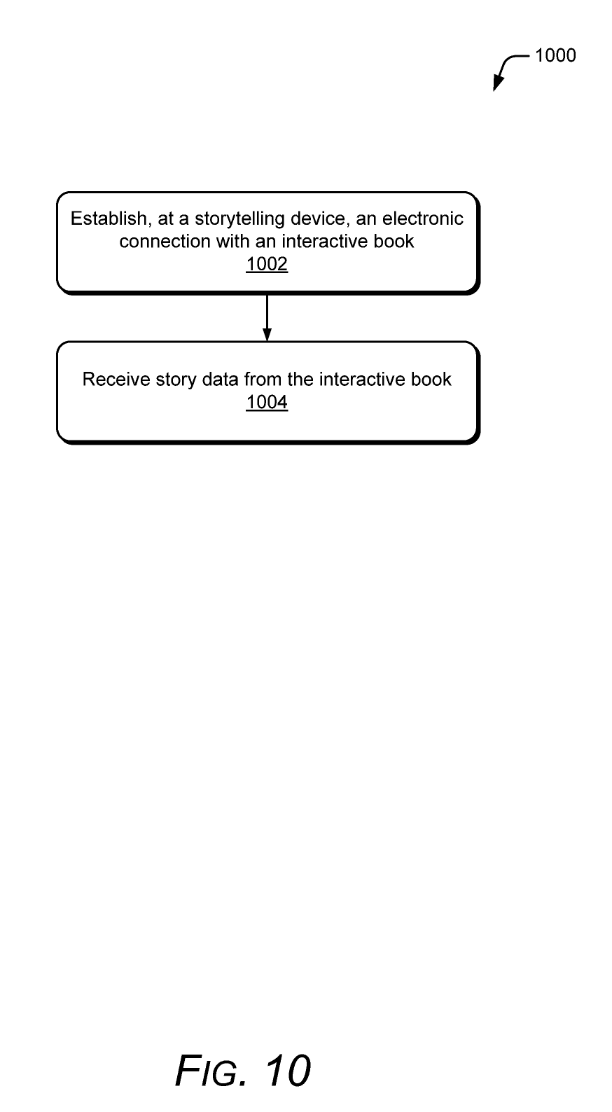

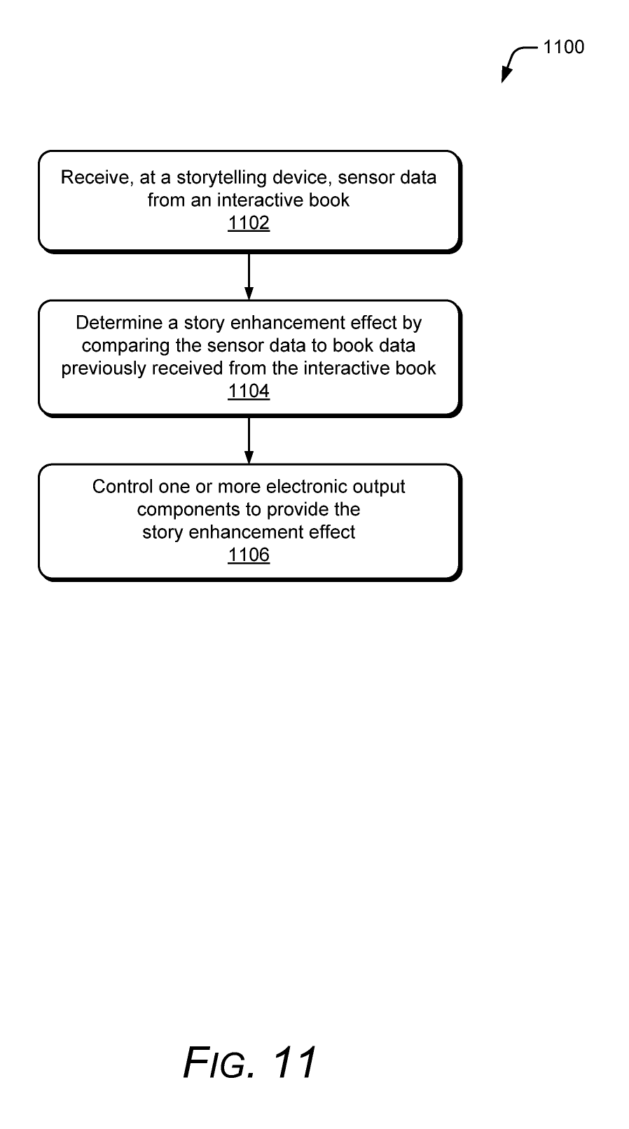

FIGS. 8 and 9 illustrate an example method 800 of communicating book data to a storytelling device, and an example method 900 of sensing user interaction with an interactive book to initiate story enhancement effects. FIGS. 10 and 11 illustrate an example method 1000 of receiving book data from an interactive book, and an example method 1100 of controlling an electronic output component to provide a story enhancement effect for an interactive book. These methods and other methods herein are shown as sets of blocks that specify operations performed but are not necessarily limited to the order or combinations shown for performing the operations by the respective blocks. In portions of the following discussion reference may be made to environment 100 of FIG. 1, example 200 of interactive book 102 of FIG. 2, example 300 of storytelling device 104 of FIG. 3, and system 400 of FIG. 4, reference to which is made for example only. The techniques are not limited to performance by one entity or multiple entities operating on one device.

FIG. 8 illustrates an example method 800 of communicating book data to a storytelling device. At 802, an electronic connection is established with a storytelling device. For example, interactive book 102 (FIG. 1) establishes an electronic connection 402 (FIG. 4) with storytelling device 104 when a user connects book interface 218 (FIG. 2) to storytelling device interface 310 (FIG. 3).

At 804, book data is communicated to storytelling device 104 to enable storytelling device 104 to control interactive book 102. For example, interactive book 102 communicates book data 216 from memory 214 to storytelling device 104. In some cases, interactive book 102 communicates book data 216 responsive to the electronic connection with storytelling device 104 being established. Alternately, interactive book 102 communicates book data 216 responsive to receiving a request from storytelling device 104 after the electronic connection is established.

FIG. 9 illustrates an example method 900 of sensing user interaction with an interactive book to initiate story enhancement effects. At 902, user interaction with interactive book 102 is sensed by one or more sensors. For example, sensors 110 (FIG. 1) sense user interaction with interactive book 102 as sensor input 404 (FIG. 4). In some cases, the user interaction corresponds to the user turning to a particular page 106 of interactive book 102. In this case, page sensor 202 (FIG. 2) senses the current page of interactive book 102. Alternately or additionally, the user interaction may be sensed by other sensors 110, such as touch input sensed by touch sensor 204, voice input sensed by microphone 206, or motion input sensed by motion sensor 208.

At 904, sensor data is generated based on the user interaction, and at 906 the sensor data is communicated to a storytelling device. For example, sensor 110 generates sensor data 406 based on the user interaction with interactive book 102. Then, sensor data 406 is communicated by sensors 110 to book interface 218 via connection circuitry 220. Book interface 218 communicates sensor data 406 to storytelling device 104 via storytelling device interface 310 (FIG. 3). Communicating sensor data 406 to storytelling device 104 causes storytelling device 104 to initiate one or more story enhancement effects.

At 908, control signals are received from the storytelling device, and at 910 a story enhancement effect is provided based on the control signals. For example, control signals 408 are received from storytelling device 104 by interactive book 102 via book interface 218. Control signals 408 are then routed from book interface 218, via connection circuitry 220, to electronic output components 112 causing electronic output components 112 to provide story enhancement effect 412 that is correlated to interactive book 102, such as by outputting light through light sources 212, or playing audio through speakers 210.

Alternately or additionally, communicating sensor data 406 to storytelling device 104 may cause story controller 318 at storytelling device 104 to transmit control signals 408 to electronic output component 114 at storytelling device 104. Electronic output component 114 at storytelling device 104 then provides story enhancement effect 410, such as by outputting light from light sources 302 to illuminate a pop-up element 108 in page 106 of interactive book 102.

FIG. 10 illustrates an example method 1000 of receiving book data from an interactive book. At 1002, an electronic connection is established with an interactive book. For example, storytelling device 104 (FIG. 1) establishes an electronic connection 402 (FIG. 4) with interactive book 102 when a user connects storytelling device interface 310 (FIG. 3) to book interface 218 (FIG. 2).

At 1004, book data is received from interactive book 102. For example, storytelling device 104 receives book data 216 from interactive book 102. In some cases, storytelling device 104 automatically receives book data 216 responsive to establishing the connection with interactive book 102. Alternately, storytelling device 104 communicates a request to interactive book 102 to cause interactive book 102 to communicate book data 216 to storytelling device 104 after the electronic connection is established. As discussed above, story controller 318 can use book data 216 to provide story enhancement effects when sensor data is received from interactive book 102.

FIG. 11 illustrates an example method 1100 of controlling an electronic output component to provide a story enhancement effect for an interactive book. At 1102, sensor data is received from interactive book 102. For example, sensor data 406 (FIG. 4) generated by sensors 110 is received from interactive book 102 via storytelling device interface 310 (FIG. 3). In some cases, sensor data 406 corresponds to a current page of interactive book 102 sensed by page sensor 202 (FIG. 2). Alternately or additionally, sensor data 406 may correspond to touch data generated by touch sensor 204, voice data generated by microphone 206, or motion data generated by motion sensor 208.

At 1104, a story enhancement effect is determined by comparing the sensor data to book data previously received from the interactive book. For example, story controller 318 of storytelling book 104 compares sensor data 406 to book data 216 previously received from interactive book 102 (e.g., step 1004 of FIG. 10).

At 1106, one or more electronic output components are controlled to provide the story enhancement effect. For example, story controller 316 communicates control signals 408 to electronic output component 114 at storytelling device 104 to cause electronic output component 114 to provide story enhancement effect 410. Alternately or additionally, story controller 316 communicates control signals 408 to electronic output component 112 at interactive book 102 to cause electronic output component 112 to provide story enhancement effect 412.

Example Computing System

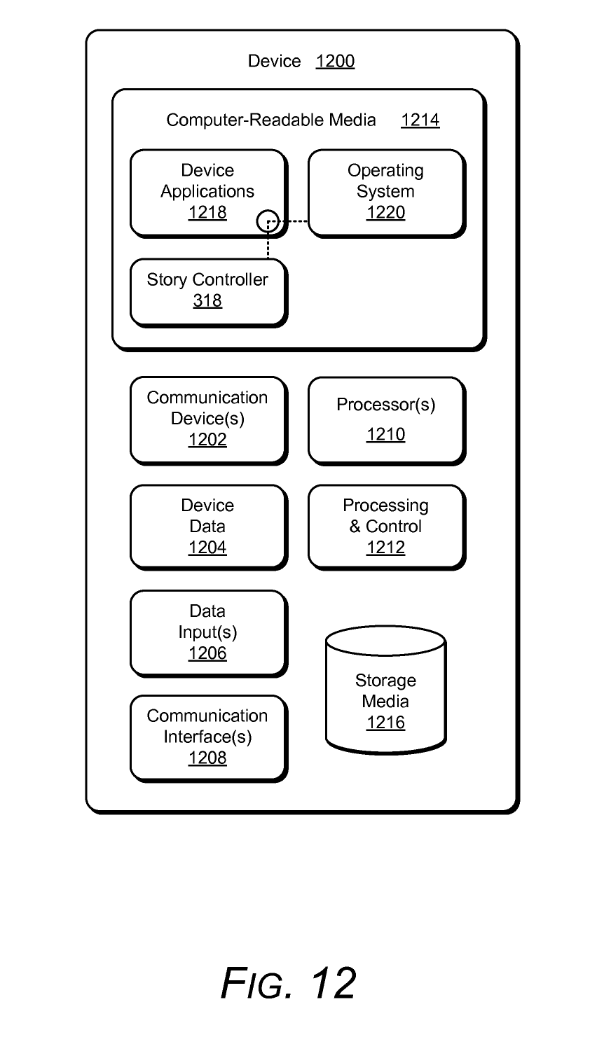

FIG. 12 illustrates various components of an example computing system 1200 that can be implemented as any type of client, server, and/or computing device as described with reference to the previous FIGS. 1-11 to implement interactive book 102 and/or storytelling device 104. In embodiments, computing system 1200 can be implemented as one or a combination of a wired and/or wireless wearable device, System-on-Chip (SoC), and/or as another type of device or portion thereof. Computing system 1200 may also be associated with a user (e.g., a person) and/or an entity that operates the device such that a device describes logical devices that include users, software, firmware, and/or a combination of devices.

Computing system 1200 includes communication devices 1202 that enable wired and/or wireless communication of device data 1204 (e.g., received data, data that is being received, data scheduled for broadcast, data packets of the data, etc.). Device data 1204 or other device content can include configuration settings of the device, media content stored on the device, and/or information associated with a user of the device. Media content stored on computing system 1200 can include any type of audio, video, and/or image data. Computing system 1200 includes one or more data inputs 1206 via which any type of data, media content, and/or inputs can be received, such as human utterances, user-selectable inputs (explicit or implicit), messages, music, television media content, recorded video content, and any other type of audio, video, and/or image data received from any content and/or data source.

Computing system 1200 also includes communication interfaces 1208, which can be implemented as any one or more of a serial and/or parallel interface, a wireless interface, any type of network interface, a modem, and as any other type of communication interface. Communication interfaces 1208 provide a connection and/or communication links between computing system 1200 and a communication network by which other electronic, computing, and communication devices communicate data with computing system 1200.

Computing system 1200 includes one or more processors 1210 (e.g., any of microprocessors, controllers, and the like), which process various computer-executable instructions to control the operation of computing system 1200 and to enable techniques for, or in which can be embodied, interactive book 102 and storytelling device 104. Alternatively or in addition, computing system 1200 can be implemented with any one or combination of hardware, firmware, or fixed logic circuitry that is implemented in connection with processing and control circuits which are generally identified at 1212. Although not shown, computing system 1200 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Computing system 1200 also includes computer-readable media 1214, such as one or more memory devices that enable persistent and/or non-transitory data storage (i.e., in contrast to mere signal transmission), examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Computing system 1200 can also include a mass storage media device 1216.

Computer-readable media 1214 provides data storage mechanisms to store device data 1204, as well as various device applications 1218 and any other types of information and/or data related to operational aspects of computing system 1200. For example, an operating system 1220 can be maintained as a computer application with computer-readable media 1214 and executed on processors 1210. Device applications 1218 may include a device manager, such as any form of a control application, software application, signal-processing and control module, code that is native to a particular device, a hardware abstraction layer for a particular device, and so on.

Device applications 1218 also include any system components, engines, or managers to implement interactive book 102 and/or storytelling device 104. In this example, device applications 1218 include story controller 318.

### CONCLUSION

Although embodiments of techniques using, and objects including, an interactive book and a storytelling device have been described in language specific to features and/or methods, it is to be understood that the subject of the appended claims is not necessarily limited to the specific features or methods described. Rather, the specific features and methods are disclosed as example implementations of the interactive book and the storytelling device.

What is claimed is:

1. A storytelling device, comprising:
one or more electronic output components;
a storytelling device interface configured to establish an electronic connection with an interactive book that includes one or more sensors; and
a story controller configured to:
receive book data from the interactive book via the storytelling device interface responsive to establishing the electronic connection with the interactive book;
receive sensor data from the one or more sensors of the interactive book via the storytelling device interface; and
responsive to receiving the sensor data, cause the one or more electronic output components to provide a story enhancement effect using the book data.

2. The storytelling device as recited in claim 1, wherein the one or more electronic output components comprise multiple light sources positioned on an outer surface of the storytelling device.

3. The storytelling device as recited in claim 2, wherein the story controller is configured to control the multiple light sources to illuminate one or more areas on a physical page of the interactive book that is open to provide the story enhancement effect.

4. The storytelling device as recited in claim 3, wherein the one or more areas comprise at least one region on a pop-up element of the physical page that is open.

5. The storytelling device as recited in claim 1, wherein at least one of the one or more electronic output components comprise a video projector, and wherein the story controller is configured to cause the video projector to project video to one or more areas on physical pages of the interactive book that is open to provide the story enhancement effect.

6. The storytelling device as recited in claim 1, wherein at least one of the one or more electronic output components comprise a display positioned on a top surface of the storytelling device, and wherein the story controller is configured to cause the display to render images or video to provide the story enhancement effect.

7. The storytelling device as recited in claim 1, further comprising a power source configured to provide power to the one or more sensors of the interactive book via the electronic connection.

8. The storytelling device as recited in claim 1, wherein the sensor data indicates a current physical page of the interactive book that is open.

9. The storytelling device as recited in claim 8, wherein the story controller is further configured to control one or more other electronic output components to provide the story enhancement effect, the one or more other electronic output components embedded in the current physical page of the interactive book that is open.

10. The storytelling device as recited in claim 9, wherein the one or more other electronic output components embedded in the current physical page of the interactive book that is open includes a speaker, and wherein the story controller is configured to control the speaker to play audio content, the audio content included in the book data.

11. A method comprising:
receiving, at a storytelling device, sensor data from an interactive book, the sensor data generated by one or more sensors integrated into the interactive book;
determining a story enhancement effect by comparing the sensor data to book data previously received from the interactive book; and
controlling one or more electronic output components to provide the story enhancement effect.

12. The method as recited in claim 11, wherein the book data comprises:
a mapping between sensor data and story enhancement effects; and
for each story enhancement effect, control signals usable to control the one or more electronic output components to provide the story enhancement effect.

13. The method as recited in claim 12, wherein controlling the one or more electronic output components to provide the story enhancement effect comprises:
selecting the story enhancement effect from the mapping between sensor data and story enhancement effects in the book data based on the received sensor data; and
communicating control signals associated with the selected story enhancement effect to the corresponding electronic output component to cause the electronic output component to provide the story enhancement effect.

14. The method as recited in claim 11, further comprising, prior to receiving the sensor data:
establishing an electronic connection with the interactive book; and
receiving the book data from the interactive book responsive to establishing the electronic connection.

15. The method as recited in claim 11, wherein the sensor data comprises page data indicating a current physical page of the interactive book that is open.

16. The method as recited in claim 15, wherein controlling the one or more electronic output components to provide the story enhancement effect comprises communicating one or more control signals to light sources at the storytelling device to cause the light sources to provide the story enhancement effect by illuminating a specific area of the current physical page of the interactive book that is open.

17. The method as recited in claim 15, wherein controlling the one or more electronic output components to provide the story enhancement effect comprises communicating one or more control signals to a video projector at the storytelling device to cause the video projector to provide the story enhancement effect by projecting video to a specific area of the current physical page of the interactive book.

18. The method as recited in claim 15, wherein controlling the one or more electronic output components to provide the story enhancement effect comprises communicating one or more control signals to an electronic output component embedded in the current physical page of the interactive book that is open to cause the electronic output component to provide the story enhancement effect.

19. The method as recited in claim 11, wherein the sensor data comprises one of:
voice data generated from voice input sensed by a microphone embedded in a physical page of the interactive book; or
touch data generated from touch input sensed by a touch sensor embedded in a physical page of the interactive book.

20. A computing device comprising:
an interface to establish an electronic connection with an interactive book;
multiple light sources positioned around an outer surface of the computing device; and
a controller configured to control the multiple light sources to illuminate specific areas of the interactive book responsive to receiving sensor data from sensors of the interactive book via the interface.
